(19) United States
(12) Patent Application Publication
(10) Pub. No.: US 2025/0203284 A1
(43) Pub. Date: Jun. 19, 2025

(54) AUTOMATIC AUDIO TUNING SYSTEM

(71) Applicant: HARMAN BECKER AUTOMOTIVE SYSTEMS GmbH, Karlsbad-Ittersbach (DE)

(72) Inventors: Fanyu MENG, Oberschleissheim (DE); Christopher OATES, Bamberg (DE); Adrian VON DEM KNESEBECK, Munich (DE); Friedrich VON TÜRCKHEIM, Hamburg (DE); Philipp Maximilian KREJCI, Ettlingen (DE)

(21) Appl. No.: 18/986,868

(22) Filed: Dec. 19, 2024

(30) Foreign Application Priority Data
Dec. 19, 2023 (DE) 102023135886.3

(51) Int. Cl. H04R 3/04; G06F 3/16; H04R 29/00

(52) U.S. Cl. CPC H04R 3/04; G06F 3/165; H04R 29/002; H04R 2430/01; H04R 2499/13

(57) ABSTRACT

Various embodiments disclose an automatic audio tuning system, the system including: a measurement engine configured to obtain first measurements of one or more parameters associated with an audio signal from one or more loudspeakers; an automatic tuning engine configured to: receive the first measurements, and generate tuning parameters based on the first measurements; a signal flow integration engine configured to: receive the tuning parameters, and generate one or more components of a signal flow, wherein each of the one or more components of the signal flow represents an audio parameter that is tuneable based on the tuning parameters; an audio signal processing engine configured to: receive the one or more components of the signal flow, and generate a playback audio signal based on the one or more components of the signal flow; and an evaluation engine configured to enable an evaluation of the playback audio signal.

### CROSS-REFERENCE TO RELATED APPLICATIONS

The present application claims priority benefit of Application No. DE 102023135886.3 titled, “AUTOMATIC AUDIO TUNING SYSTEM,” filed on Dec. 19, 2023. The subject matter of this related application is hereby incorporated herein by reference.

### TECHNICAL FIELD

The present disclosure generally relates to an automated audio tuning system. More particularly, the present disclosure relates to an automated audio tuning system that can be used to optimize the sound output of a plurality of loudspeakers in an audio system based on measurements of the sound output and user input. The present disclosure can be employed in multimedia systems having loudspeakers, for example in a vehicle.

### BACKGROUND

Multimedia systems, such as vehicle audio/video systems, home theatre systems and home audio systems are well known. Such systems typically include multiple components that include a sound processor driving loudspeakers with amplified audio signals. Multimedia systems can be installed in various configurations with different components. In addition, such multimedia systems can be installed in listening spaces of different sizes, shapes and configurations. The components of a multimedia system, the configuration of the components and the listening space in which the system is installed all can have significant impact on the audio sound produced.

Once installed in a listening space, a system can be tuned to produce a desirable sound field within the space. Tuning can include adjusting the equalization, delay, and gains to compensate for the equipment and the listening space. Automatic sound field equalization is a well-known technology that contributes to a balanced listening experience, which is widely desired in the fields of vehicles, home theatres and studios. During the process of sound field equalization, or tuning as a commonly used equivalent term, measurement data is to be collected as the input of tuning and evaluated to validate the tuning results. However, known tuning tools do not provide a complete chain of automatic tuning functionalities. The present disclosure aims to address this need and to provide an improved automatic audio tuning system.

### SUMMARY

According to the present disclosure, there is provided an end-to-end tool for automatic sound field equalization. A typical application of automatic sound field equalization is in vehicles. The present disclosure focuses on the application in vehicles. Nevertheless, the present disclosure is also applicable in other environments, e.g., rooms containing a studio or home theatre or audio systems.

The present disclosure provides an automatic audio tuning system, the system including: a measurement engine to obtain first measurements of one or more parameters associated with an audio signal from one or more loudspeakers; an automatic tuning engine to receive the first measurements and to generate tuning parameters based on the first measurements; a signal flow integration engine to receive the tuning parameters and to generate one or more components of a signal flow, wherein each of the one or more components of the signal flow represents an audio parameter that is tuneable based on the tuning parameters; an audio signal processing engine to receive the one or more components of the signal flow, and to generate a playback audio signal based on the one or more components of the signal flow; and an evaluation engine to enable an evaluation of the playback audio signal.

In an embodiment, the evaluation engine is configured to obtain second measurements based on the playback audio signal based on the one or more components of the signal flow, and/or the evaluation engine is configured to enable subjective listening on the playback audio signal based on the one or more components of the signal flow. Based on the objective and/or subjective evaluation results, the user decides to re-tune or go to fine tuning.

In another embodiment, the system includes a user interface configured to enable a user to adjust one or more tuning parameters, wherein the signal flow integration engine is configured to adjust said one or more components of the signal flow based on the user-adjusted tuning parameters.

Accordingly, the disclosed system implements a complete chain of tuning functions, starting from a measurement of impulse responses of all loudspeakers, automatic tuning, integration into an overall audio processing architecture, also called audio signal flow, to subjective and objective evaluation and subsequent manual fine-tuning. Based on the measured impulse responses and tuning configurations, tuning parameters can be generated. A user can decide whether to re-tune by reconfiguring the system or proceeding to fine-tuning, based on either subjective or objective validation.

The present disclosure enables performing a baseline tuning, e.g., tuning/adjusting of equalization filters, time and gain alignment, with less experience, expertise, time and costs than conventional systems. In particular, the present disclosure provides an end-to-end tool that enables automating the process of tuning, thereby accelerating the tuning process and saving time to focus on subjective refinement on top of the baseline tuning. Also, the disclosed system enables controlling any number of parameters/variables, thereby achieving a balanced listening experience across the seats in a car, for example. Further, the disclosed system enables making the tuning more objective and thus more uniform across different cars or environments.

The system can be implemented by hardware or software or a combination thereof. For example, the system can be implemented by instructions executable on a computer. In an embodiment, the system is implemented in an automotive vehicle. In particular, the system can be connected to or form part of an in-vehicle audio system.

The present disclosure also provides a method for tuning an audio signal, the method including: measuring one or more parameters associated with an audio signal from one or more loudspeakers; generating tuning parameters based on the measured parameters; generating one or more components of a signal flow, wherein each of the one or more components of the signal flow represents an audio parameter that is tuneable based on the tuning parameters; generating a playback audio signal based on the one or more components of the signal flow; and evaluating the playback audio signal and, optionally, adjusting the tuning parameters based on the evaluation (re-tuning), or go to fine tuning. From fine tuning the user can also go to re-tuning. The method can include any of the features and functionalities that are described herein in connection with the system.

### BRIEF DESCRIPTION OF THE DRAWINGS

The features, objects, and advantages of the present disclosure will become more apparent from the detailed description set forth below in conjunction with the drawings, in which:

FIG. 1 schematically illustrates the components and workflow of a system according to an embodiment of the present disclosure;

FIG. 2 schematically illustrates a measurement operation by a system according to an embodiment of the present disclosure;

FIG. 3 illustrates a user interface of a system according to an embodiment of the present disclosure including a speaker configuration and measurement parameters;

FIG. 4 schematically illustrates an automatic tuning procedure by a system according to an embodiment of the present disclosure;

FIG. 5 illustrates a user interface for controlling an automatic tuning procedure by a system according to an embodiment of the present disclosure;

FIG. 6 shows a measured response of an audio system and a target curve for an automatic tuning procedure by a system according to an embodiment of the present disclosure;

FIG. 7 shows a tuned response of the audio system and the target curve of FIG. 6;

FIG. 8 illustrates a signal flow with audio components corresponding to filter (biquad for example), delay and gain generated by a system according to an embodiment of the present disclosure;

FIG. 9 illustrates a biquad audio component in a user interface of a system according to an embodiment of the present disclosure;

FIG. 10 illustrates a delay audio component in a user interface of a system according to an embodiment of the present disclosure; and

FIG. 11 illustrates a gain audio component in a user interface of a system according to an embodiment of the present disclosure.

### DETAILED DESCRIPTION

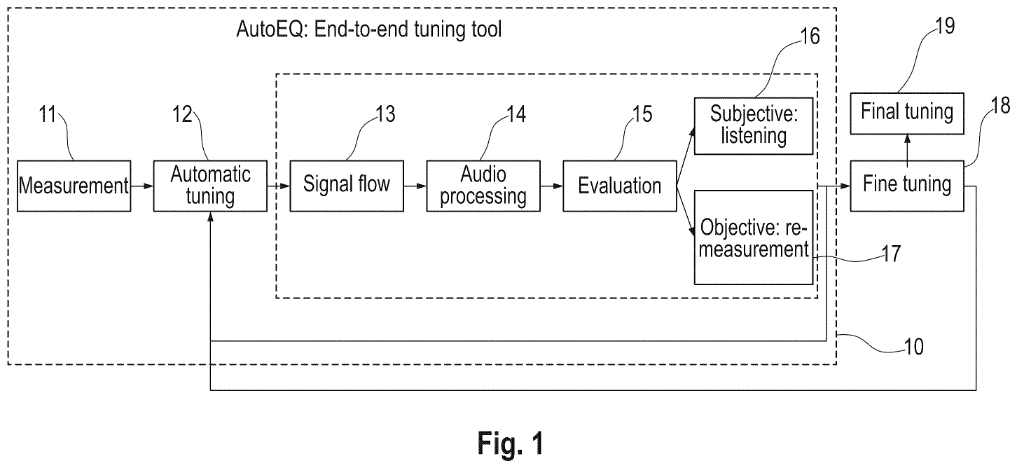

The present disclosure describes a system that provides a platform for automatically tuning an audio system. The system implements a complete tuning chain, including measurement, auto-tuning, signal flow integration, audio processing and evaluation. FIG. 1 illustrates such system 10 in accordance with an embodiment of the present disclosure. The system 10 includes a measurement engine 11 for measuring one or more audio parameters, e.g., impulse responses of one or more loudspeakers of an audio system (not shown). The audio parameters are transmitted to an automatic tuning engine 12 which generates tuning parameters based on the measurements by the measurement engine 11. The tuning parameters are transmitted to a signal flow engine 13. The signal flow engine 13 generates one or more components of an audio signal flow, wherein each of the one or more components represents an audio parameter that is tuneable based on the tuning parameters. The output of the audio processing engine 14. The audio processing engine 14 generates a playback audio signal based on the one or more components of the signal flow. The output of the audio processing engine 14 can be evaluated by an evaluation engine 15. The evaluation engine 15 enables a user to evaluate the tuning results by “subjective” listening (element 16) or “objective” re-measurement (element 17). Based on the outcome of the subjective listening 16 and/or the measurement 17, the user can decide to go back to automatic tuning, as illustrated by the arrow to the automatic tuning engine 12. Instead of going back to automatic tuning, the user can directly go to fine-tuning via a fine-tuning module 18. The fine-tuning module 18 enables a further adjustment of the tuning parameters. The fine-tuning too can be automated, based on a measurement feedback loop, and/or the fine-tuning can include adjustments that a user can make through a user interface of the system. Based on the fine-tuning results, the user can loop back to automatic tuning for re-tuning, until satisfying results are obtained, as illustrated by the arrow from the fine-tuning module 18 to the automatic tuning engine 12.

In the following, the elements of a system according to an embodiment of the present disclosure, as illustrated in FIG. 1, will be described in more detail.

### Measurement

The measurement engine 11 enables different types of measurements, e.g., impulse response measurements, total harmonic distortion (THD) measurements, phase and frequency measurements, signal-to-noise ratio (SNR) measurements, polarity measurements, etc., and directly feeds the measurement data into the automatic tuning engine 12. The measurements can relate to various loudspeaker types and configurations. The measurements can be performed by different types and configurations of microphones or microphone arrays. The loudspeaker and/or the microphone layouts can be configured by a user through a user interface of the system.

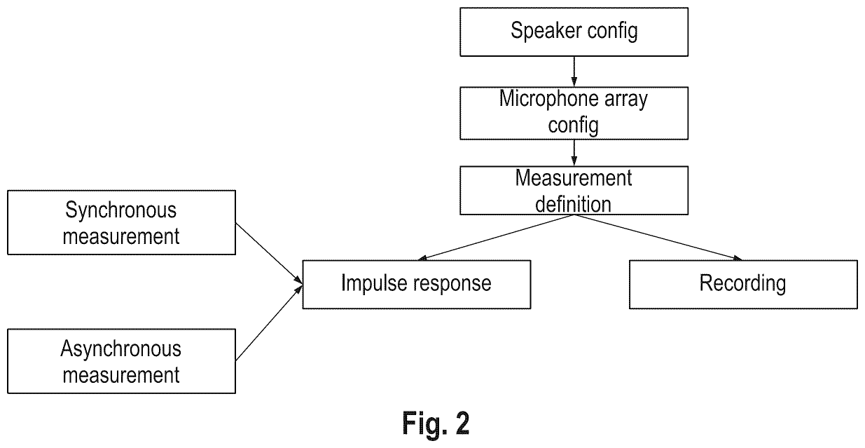

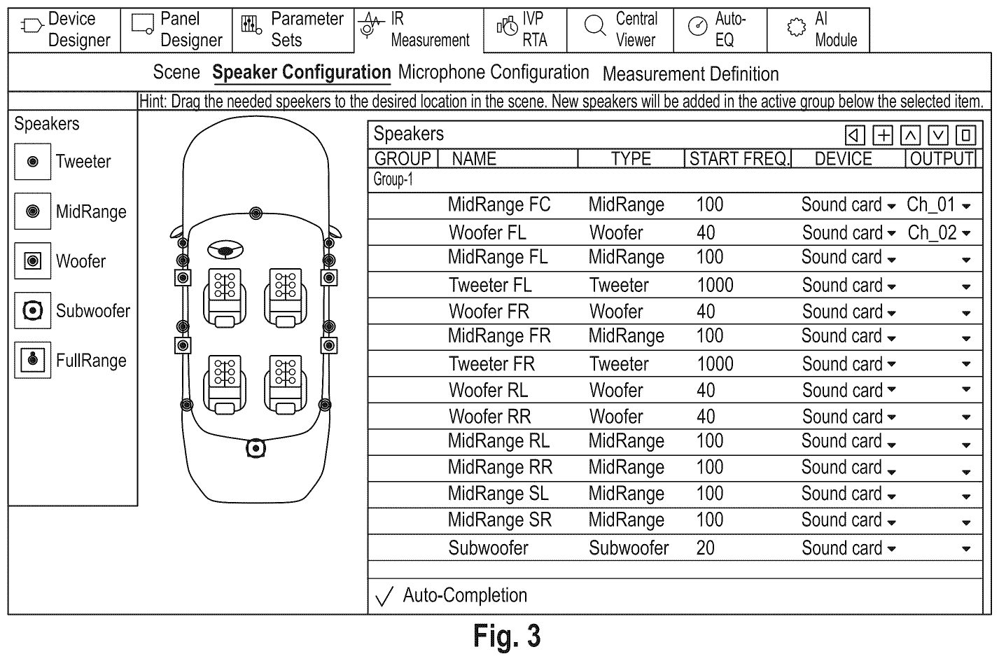

FIG. 2 shows an exemplary flow chart of the steps taken by the measurement engine 11 according to an embodiment of the present disclosure. FIG. 3 illustrates an exemplary use case relating to a car audio system with a subwoofer, woofers, midrange and tweeters speakers, wherein the measurements are made with a microphone array across four seats. The loudspeaker configuration is shown on the left-hand side of FIG. 3.

### Automatic Tuning

The system according to embodiments of the present disclosure includes a user interface to enable a user to define targets, for example spectral and temporal behaviors, sound stage, spatial balancing, immersiveness and sound depth. The user interface enables the user to configure parameters to achieve the desired target behavior. A backend algorithm, also referred to as “solver”, processes the targets and the user defined configurations to obtain filter parameters, gains and delays as a tuning output. The solver can have a modular, extendible architecture, thereby enabling an expansion of the targets and configurations for different application scenarios. For example, by adding different use cases and tuning modes, various users' or customers' preferences can be implemented.

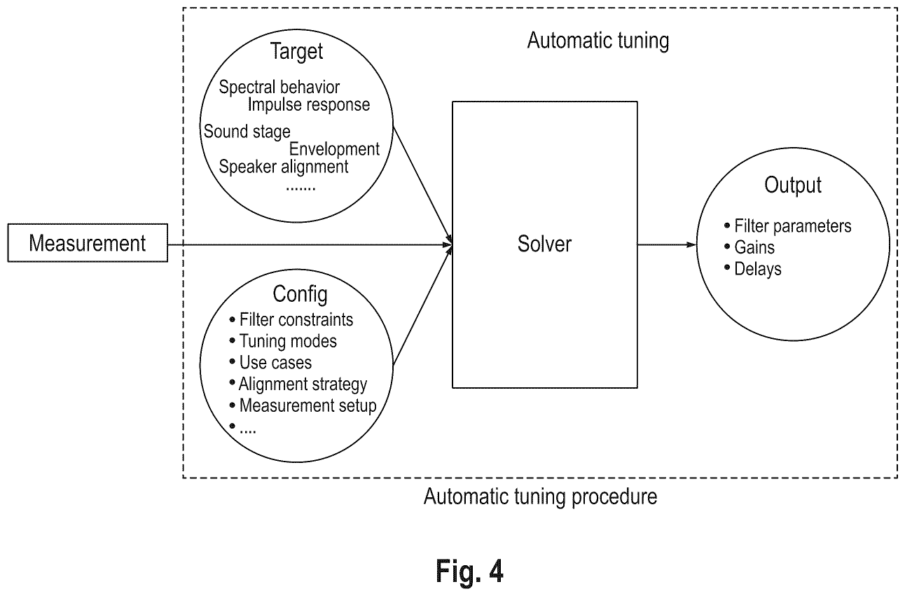

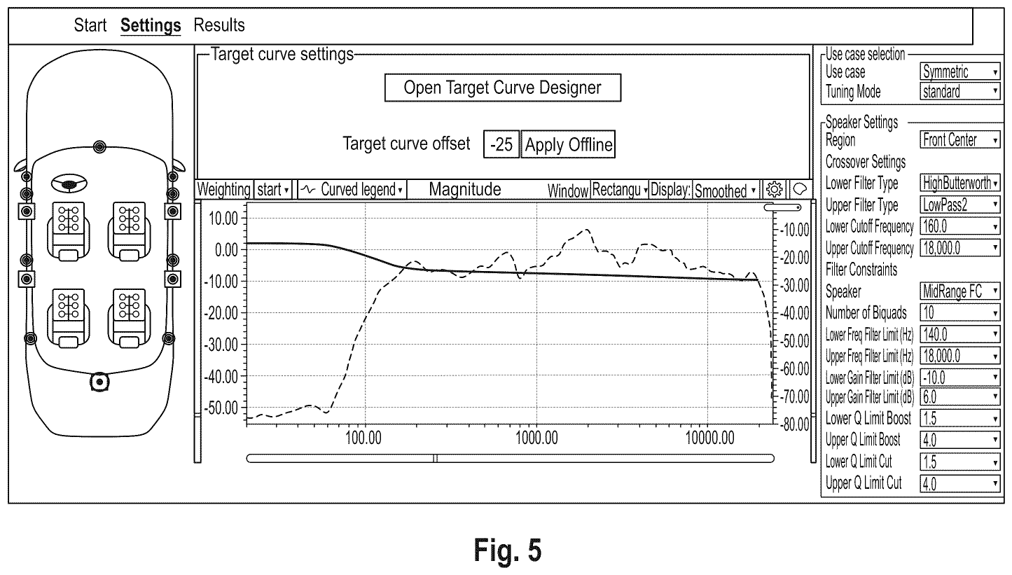

FIG. 4 illustrates examples of user-defined requirements and configurations included in the automatic tuning process. FIG. 5 illustrates a configuration panel (user interface) of the automatic tuning engine 12, including a loudspeaker architecture, microphone selection, target curve definition, speaker and filter configurations and graphs of target curve and measurement responses.

Systems according to embodiments of the present disclosure can include one or more of the following features:

User defined target tuning curve: The user can define a target curve in the frequency domain through a user interface of the system. The target curve can represent a preferred listening experience. The measured responses of loudspeakers are tuned to achieve or approximate the target curve. The responses can be equalized by digital audio filters, e.g. IIR biquad filters or FIR filters, delays and gains, for example.

Balancing between seats: In an in-vehicle audio system, a microphone array used for measurement and tuning can be configured through a user interface. The configuration can include a selection and weighting of microphones, thereby to enable a user to decide which seat to focus on, and how much weighting to give each seat in a configuration of multiple seats.

Delay calculation: The automatic tuning engine 12 can include a delay detection scheme using impulse responses. Thereby, the loudspeaker with the longest delay can be selected as a reference loudspeaker. The other loudspeakers can be aligned with the reference loudspeaker with user-defined delay offsets.

Flexible grouping for gain alignment: The automatic tuning engine 12 can be configured to perform gain alignment towards the target curve among loudspeakers within a region within a room or car, for example, or among regions within the room or car. To align regions, groups of loudspeakers can be flexibly configured, and relative level offsets can be defined.

Multiple and extendable use cases and tuning modes: To have a balanced tuning of left and right loudspeakers, for example, a symmetric use case can be defined to combine left and right paired loudspeaker signals for tuning. Taking car as example, front speakers use the measurements of the microphone array placed on the driver seat, and rear speakers use the measurements of the microphone array on the rear right seat, and subwoofer uses both microphone arrays. An asymmetric use case with different “focus seats” as a different tuning mode is also available. In the asymmetric use case, the measurement data for one selected seat and one speaker only is used for further processing/tuning. For example, a “driver” tuning mode only uses data from microphones that arranged on or near a driver's seat. The different use cases and the selection of “focus seats” can be entered through a user interface of the automatic tuning engine 12, for example.

Nonlinear multivariable optimizer: The automatic tuning engine 12 can include an optimizer to provide optimized filter parameters to equalize the measured response with respect to the target curve. The optimizer is constrained by multiple boundaries, e.g., a quality factor, frequency and gain, thereby to shape the filters to make the tuned measurement responses to achieve the target. The filter parameters can be converted to coefficients to be easily deployed in the signal flow.

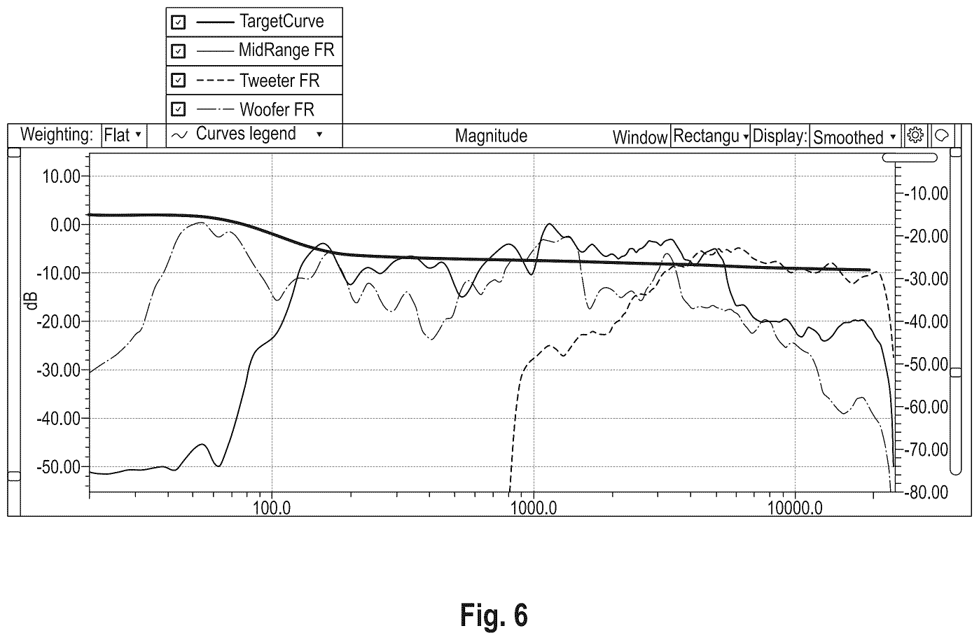

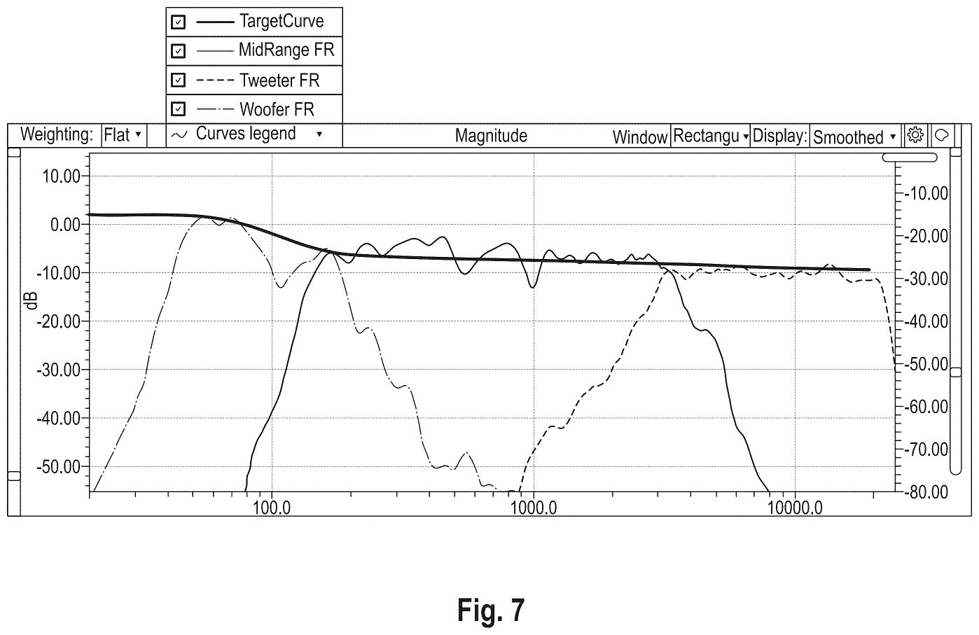

FIG. 6 and FIG. 7 illustrate responses before and after tuning, respectively, versus a user defined target curve.

### Signal Flow Integration

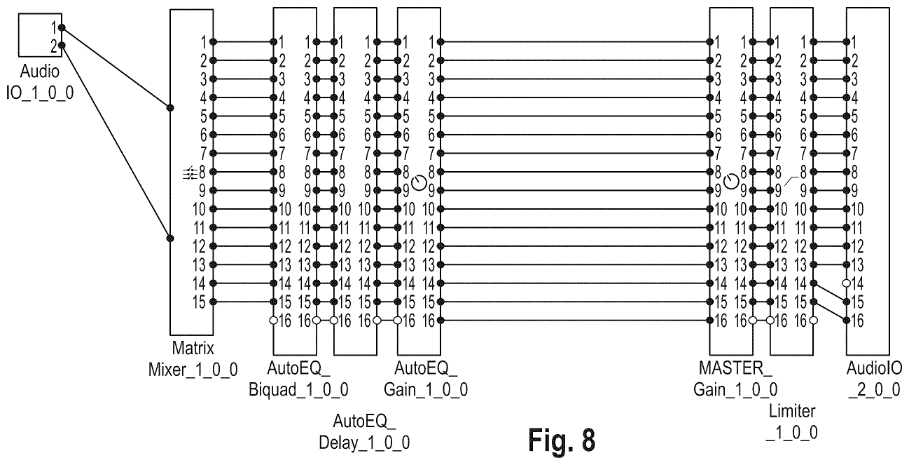

In a system according to embodiments of the present disclosure, the tuning function can be embedded in a larger software architecture including additional features or technologies. In an embodiment, the tuning function achieved by a signal flow tool, with which the user can implement more complex signal flows and software architectures in the form of multiple audio objects (gains, delays, complex algorithms etc.). Such audio objects are also referred to as audio components in the present disclosure. The signal flows can run on target processors, for example, and be tested in real time in a PC environment, for example. Audio blocks used for the tuning, e.g., equalizer (EQ) blocks, gain blocks, delay blocks, can be created in or as part of the signal flow. An example is illustrated in FIG. 8. The signal flow integration engine 13 can be configured to write the tuning results, represented by the tuning parameters output by the automatic tuning engine 12, directly into these blocks. The signal flow can then be analyzed in real time, listened to by a user, and/or loaded onto a target processor, such as a head unit or audio amplifier in automotive applications.

### Evaluation/Validation

A system according to embodiments of the present disclosure provides an integrated signal flow, wherein the tuning can be applied to audio playback signals. Depending on the user's preferences, the playback can be used for a re-measurement, for an objective evaluation of the tuning, or for a subjective assessment of the tuning performance, for example by listening. Based on the evaluation, the user can further adjust the tuning parameters according to their specific preferences using the integrated signal flow and audio object control tools, e.g., user interface panels and real-time analyzers, or adjust the configuration to go back to automatic tuning engineer for re-tuning

### Manual Fine Tuning

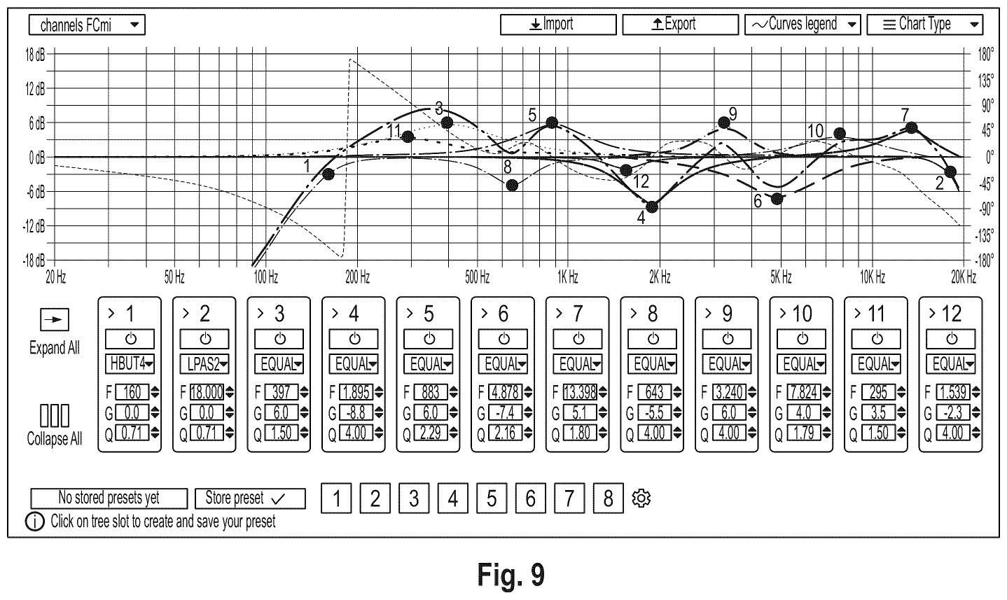

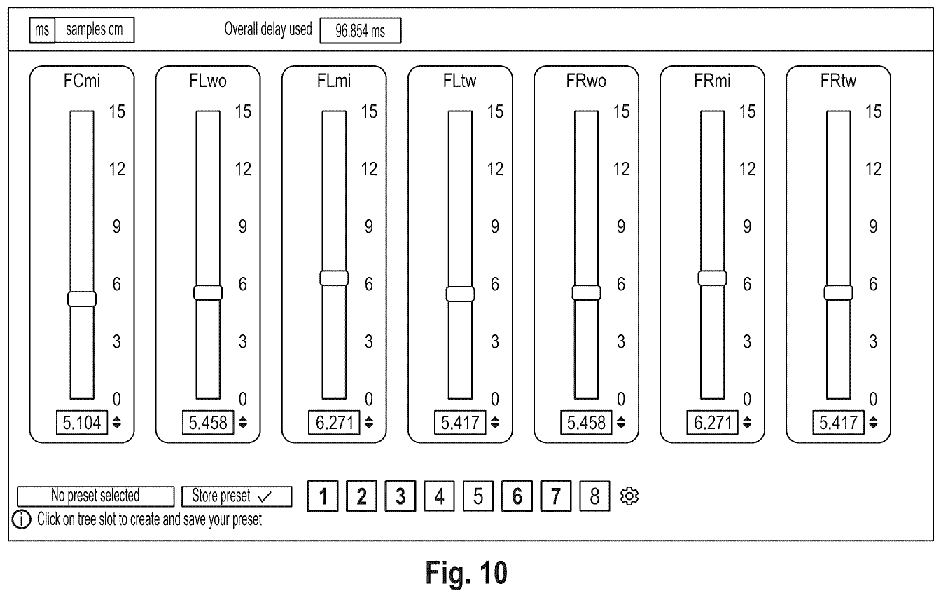

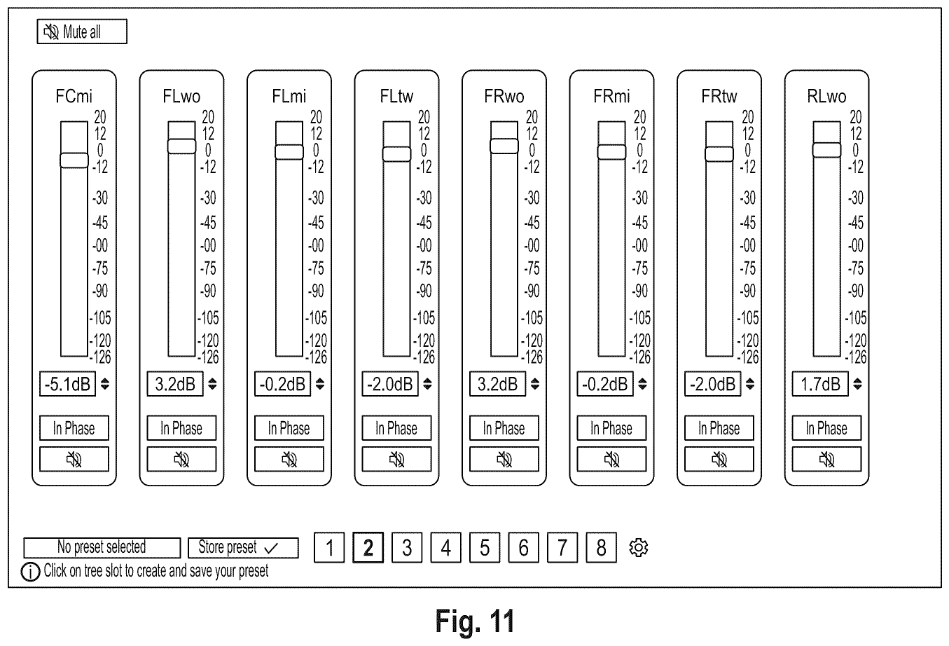

In a system according to embodiments of the present disclosure, the tuning results can be made fully visible in the signal flow. Based on the subjective/objective evaluation, the user has straight access to the tuning parameters and can modify them for fine-tuning. FIGS. 9, 10 and 11 illustrate the filter (IIR biquad filter), delay and gain panels respectively, together with the tuning results, which can be modified further by the user.

Accordingly, the described system provides an end-to-end tool, which contains aspects for baseline tuning, such as measurement, tuning, signal flow integration and evaluation. The described system also enables manual fine tuning based on the baseline tuning. In particular, the system can include or provide the following features and technical advantages:
Measurement
   Flexible selection and configuration of loudspeaker types and layouts.
   Synchronous and asynchronous modes of measurements to derive impulse responses and other signal representations, including direct recording.
   Measurement validation to cross-check SNR, THD and polarity.
Automatic tuning
   Flexible and extendable configurations to meet different users' preferences.
   Balance between different seats.
   Fast and consistent tuning.
Signal flow integration
   Tuning results are directly integrated in the signal flow and can be immediately sent to processors and loudspeakers.
   The signal flow can be deployed on any hardware.
Validation
   Objective: By integrating the tuning parameters in the signal flow, re-measurements can be performed to validate if the target is achieved.
   Subjective: The signal flow integration enables real-time listening with the tuning applied to music.
Manual fine tuning
   The tuning parameters are fully transparent, which enables the users to perform manual fine tuning based on the baseline tuning results.
Flexible re-tuning
   Judging from subjective and/or objective evaluation, automatic tuning can be retriggered for re-tuning.
   Judging from the fine tuning results, automatic tuning can be retriggered for re-tuning.

The described system provides a platform to automatically tune an audio system, implementing a full tuning chain including measurement, tuning, signal flow integration and evaluation. Compared to manual baseline tuning, the system delivers faster and more consistent results and therefore is more efficient in terms of time and cost. The system enables more consistent tuning results across different cars or other environments. In addition, the automatic tuning can balance the tuning across multiple seats. The user interface enables flexible and extendible configurations and targets that the user can manipulate and select. Subjective and objective evaluations are enabled, and the audio can be re-tuned and/or manually fine-tuned according to the user's requirements.

The described system can be applied in various environments, for example in vehicles, home theatres and studios.

What is claimed is:

1. An automatic audio tuning system, the system comprising:
a measurement engine configured to obtain first measurements of one or more parameters associated with an audio signal from one or more loudspeakers;
an automatic tuning engine configured to:
receive the first measurements, and
generate tuning parameters based on the first measurements;
a signal flow integration engine configured to:
receive the tuning parameters, and
generate one or more components of a signal flow, wherein each of the one or more components of the signal flow represents an audio parameter that is tuneable based on the tuning parameters;
an audio signal processing engine configured to:
receive the one or more components of the signal flow, and
generate a playback audio signal based on the one or more components of the signal flow; and
an evaluation engine configured to enable an evaluation of the playback audio signal.

2. The system of claim 1, wherein the tuning parameters represent at least one of a filter parameter, a temporal parameter, a spectral parameter, a gain, a delay, or an EQ parameter.

3. The system of claim 1, wherein the evaluation engine is further configured to:
obtain second measurements based on the playback audio signal; and
enable at least one of a manual verification of the tuning parameters, an automatic verification of the tuning parameters, or an adjustment of the tuning parameters.

4. The system of claim 1, further comprising a user interface configured to enable a user to adjust at least one of the tuning parameters, wherein the signal flow integration engine is further configured to adjust the one or more components of the signal flow based on the user-adjusted tuning parameters.

5. The system of claim 4, wherein the tuning parameters include at least one of a filter parameter, a temporal parameter, a spectral parameter, a gain, a delay, or an EQ parameter.

6. The system of claim 1, further comprising a user interface configured to enable a user to define a target curve in a frequency domain, wherein the automatic tuning engine is further configured to generate the tuning parameters based on the target curve.

7. The system of claim 1, further comprising a user interface configured to:
enable a user to define a configuration of one or more seats in a vehicle in which the playback audio signal is to be played back; and
enable a user to associate a weight to each of the one or more seats,
wherein the automatic tuning engine is further configured to generate the tuning parameters based on at least one of the user-defined configurations of the one or more seats or the weights associated with each of the one or more seats.

8. The system of claim 1, wherein the system is further configured to:
determine distances between the one or more loudspeakers and a reference point by detecting delays in impulse responses of the one or more loudspeakers,
wherein the system further comprises a user interface configured to enable a user to select a first loudspeaker of the one or more loudspeakers as a reference, and to define delay offsets for a second loudspeaker of the one or more loudspeakers,
wherein the automatic tuning engine is configured to generate the tuning parameters based on the selected first loudspeaker and user-defined delay offsets.

9. The system of claim 1, wherein the system further comprises:
a user interface configured to enable a user to:
group the one or more loudspeakers within one or more regions, and
define relative level offsets,
wherein the automatic tuning engine is configured to perform gain alignment towards a user-defined target curve among the one or more loudspeakers within the one or more regions.

10. The system of claim 1, wherein:
the system is operable in at least one of a symmetric mode or an asymmetric mode,
during operation in the symmetric mode, the automatic tuning engine is further configured to combine measured responses of left and right paired loudspeaker signals with respect to a seat of a vehicle in which the playback audio signal is to be played back,
during operation in the asymmetric mode, the automatic tuning engine is further configured to process the first measurements from a loudspeaker of the one or more loudspeakers at a position of a selected seat of the vehicle in which the playback audio signal is to be played back,
the automatic tuning engine is further configured to generate the tuning parameters based on a selection of the at least one of the symmetric mode or the asymmetric mode.

11. The system of claim 1, wherein the automatic tuning engine is further configured to generate the tuning parameters by generating biquad parameters, delays and gains to equalize a measured response with respect to a user-defined target curve.

12. The system of claim 1, wherein the measurement engine is further configured to:
measure at least one of an impulse response, a THD, phase, a frequency, a SNR, or a polarity; and
perform synchronous and asynchronous measurements of the one or more parameters associated with the audio signal.

13. The system of claim 1, further comprising:
at least one of one or more microphones or a microphone array to perform the measurements,
wherein the at least one of one or more microphones or the microphone array are configurable to perform measurements with respect to at least one of different types or different layouts of the one or more loudspeakers.

14. The system of claim 1, wherein the system is implemented by at least one of instructions executable on a computer or in an automotive vehicle, and wherein the system is associated with an in-vehicle audio system.

15. A computer-implemented method for tuning an audio signal, the method comprising:
measuring one or more parameters associated with the audio signal from one or more loudspeakers;
generating tuning parameters based on the one or more parameters;
generating one or more components of a signal flow, wherein each of the one or more components of the signal flow represents an audio parameter that is tuneable based on the tuning parameters;
generating a playback audio signal based on the one or more components of the signal flow;
evaluating the playback audio signal; and
adjusting the tuning parameters based on the evaluation.

16. The method of claim 15, further comprising:
obtaining second measurements based on the playback audio signal; and
enabling at least one of a manual verification of the tuning parameters, an automatic verification of the tuning parameters, or an adjustment of the tuning parameters.

17. The method of claim 15, further comprising:
enabling a user to define a target curve in a frequency domain, wherein the tuning parameters are further generated based on the target curve.

18. The method of claim 15, further comprising:
determining distances between the one or more loudspeakers and a reference point by detecting delays in impulse responses of the one or more loudspeakers; and
enabling a user to select a first loudspeaker of the one or more loudspeakers as a reference, and to define delay offsets for a second loudspeaker of the one or more loudspeakers, wherein the tuning parameters are further generated based on the selected first loudspeaker and user-defined delay offsets.

19. The method of claim 15, wherein the tuning parameters are further generated by generating biquad parameters, delays and gains to equalize a measured response with respect to a user-defined target curve.

20. The method of claim 15, further comprising:
measuring at least one of an impulse response, a THD, phase, a frequency, a SNR, or a polarity; and
performing synchronous and asynchronous measurements of the one or more parameters associated with the audio signal.
